(19) United States
(12) Patent Application Publication
(10) Pub. No.: US 2026/0202358 A1
(43) Pub. Date: Jul. 16, 2026

(54) ARTICLE INSPECTION DEVICE

(71) Applicant: ANRITSU CORPORATION, Kanagawa (JP)

(72) Inventors: Kazunori NAKAYAMA, Kanagawa (JP); Naoya SAITO, Kanagawa (JP)

(21) Appl. No.: 19/439,580

(22) Filed: Jan. 5, 2026

(30) Foreign Application Priority Data
Jan. 16, 2025 (JP) 2025-006150

(51) Int. Cl. G01N 23/04; G01N 23/18; G06F 3/041; G06F 3/044; G06F 3/0482; G06F 3/04845; G06F 3/0488; H04N 5/32

(52) U.S. Cl. CPC G01N 23/04; G01N 23/18; G06F 3/0416; G06F 3/044; G06F 3/0482; G06F 3/04845; G06F 3/0488; H04N 5/32; G01N 2223/1016; G01N 2223/408

(57) ABSTRACT

An article inspection device that inspects quality of a transported article by imaging the article as an inspection object and performing image processing on an inspection image of the article, which is obtained by the imaging, includes an image storage unit that stores the inspection image of the article, a display unit that displays the inspection image of the article, which is stored in the image storage unit, designation means for designating any position of the inspection image of the article, which is displayed on the display unit, through double tapping and a display control unit that causes the display unit to display a position of the inspection image of the article, which is designated by the designation means, in an enlarged manner at a predetermined enlargement ratio.

### TECHNICAL FIELD

The present invention relates to an article inspection device that images a transported article to be inspected and that performs image processing on an inspection image of the article obtained by the imaging to inspect quality of the article.

### BACKGROUND ART

In the related art, as an article inspection device that inspects the quality of an article, for example, an X-ray inspection device that inspects an inspection object using X-rays is known as disclosed in Patent Documents 1 to 3 below. In the X-ray inspection devices disclosed in Patent Documents 1-3, various types of information, cross-sectional waveform images, and the like are displayed using an inspection image of the inspection object by operating a touch panel.

To describe specific display content through the operation of the touch panel, in the X-ray inspection device of Patent Document 1, inspection information indicating an inspection state using the inspection image of the inspection object is displayed on an inspection state display unit, and at least one piece of information of the inspection information displayed on the inspection state display unit is enlarged and displayed in an upper region of the inspection image display unit.

In addition, in the X-ray inspection device of Patent Document 2, the inspection image of the inspection object is displayed, and a projection image based on a two-dimensional cross-sectional waveform image in which each peak value of a grayscale level in a direction orthogonal to a transport direction of the inspection image of the inspection object is drawn along the transport direction is displayed.

Further, in the X-ray inspection device of Patent Document 3, the presence or absence of a contained foreign matter in the inspection object is determined based on the inspection image of the inspection object, and based on the determination result, an inspection result of the inspection object during X-ray exposure, a two-dimensional plane image, a cross-sectional waveform image of one line in a direction substantially orthogonal to the transport direction of the inspection object, and a three-dimensional perspective bird’s-eye view waveform image of the entire inspection object viewed obliquely from above are selectively displayed.

### Related art Document

### Patent Document

[Patent Document 1] JP-A-2016-114415

[Patent Document 2] JP-A-2016-180712

[Patent Document 3] JP-A-2004-028686

### DISCLOSURE OF THE INVENTION

### Problem that the Invention is to Solve

However, in the article inspection device of the related art, in a case of enlarging/reducing the inspection image of the inspection object to a desired size of view, a plurality of stages of key operations are required, such as displaying whether to perform enlargement or reduction of the inspection image of the inspection object in an enlargement/reduction mode by operating a function key to select enlargement or reduction and then setting a desired enlargement/reduction rate by operating an increase and decrease key. However, in the enlargement/reduction mode, since the inspection image is enlarged/reduced with an upper left of a display screen as reference, the inspection image is not always enlarged or reduced around a center that is a portion desired by the user, and a key operation is further required in order to adjust a display position to a portion of the inspection image desired to be viewed.

However, in this type of article inspection device, with the improvement of inspection accuracy due to recent technological advancement, finer inspection is possible, and the number of operations related to setting is also increased and complicated, so that further improvement of operability is desired.

Thus, the present invention has been devised in consideration of the above problems, and an object thereof is to provide an article inspection device that can improve operability.

### Means for solving the problem

An article inspection device according to an embodiment of the present invention that inspects quality of a transported article by imaging the article as an inspection object and performing image processing on an inspection image of the article, which is obtained by the imaging, the article inspection device including:

an image storage unit that stores the inspection image of the article;

a display unit that displays the inspection image of the article, which is stored in the image storage unit;

designation means for designating any position of the inspection image of the article, which is displayed on the display unit, through double tapping; and

a display control unit that causes the display unit to display a position of the inspection image of the article, which is designated by the designation means, in an enlarged manner at a predetermined enlargement ratio.

The article inspection device according to the embodiment of the present invention,

in which the display control unit causes an entire inspection image of the article to be displayed as a thumbnail in a part of the display unit.

The article inspection device according to the embodiment of the present invention, further including:

a projection image generation unit that generates a projection image which is a two-dimensional cross-sectional waveform image in which a maximum value of a density of the inspection image of the article on one axis, of a horizontal axis and a vertical axis in a transport direction, is drawn along the other axis,

in which the display control unit disposes and displays the projection image created by the projection image generation unit with the horizontal axis in the transport direction as the other axis by making the projection image correspond to the inspection image of the article.

The article inspection device according to the embodiment of the present invention,

in which the projection image is switchable between waveform display of an entire inspection image of the article and waveform display of a section of the inspection image of the article, which is displayed in an enlarged manner.

The article inspection device according to the embodiment of the present invention,

in which the designation means is configured with a capacitive touch panel disposed on the display unit.

The article inspection device according to the embodiment of the present invention,

in which the display control unit returns the inspection image displayed in an enlarged manner to the inspection image of the article before enlargement in response to designation of double tapping of the designation means and causes the display unit to display the inspection image.

### Advantage of the Invention

According to the present invention, in response to designation for enlarging the inspection image of the inspection object through double tapping, an enlargement operation for displaying the inspection image of the inspection object is facilitated. In addition, by displaying the entire thumbnail, which position of the entire inspection image is enlarged can be easily ascertained when a part of the inspection image of the inspection object is enlarged. Further, when a part of the inspection image of the inspection object is displayed in an enlarged manner, the projection image in conjunction therewith can be displayed.

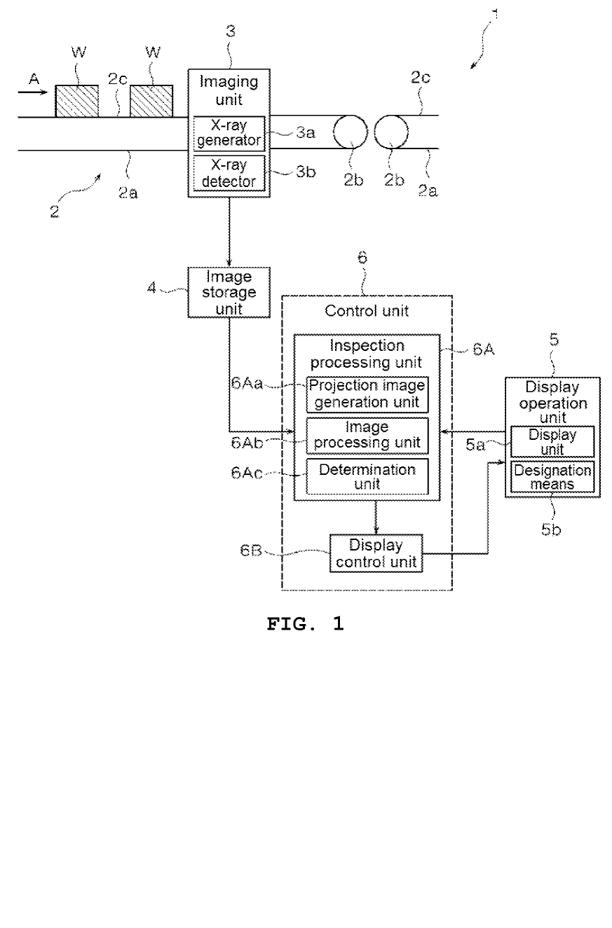

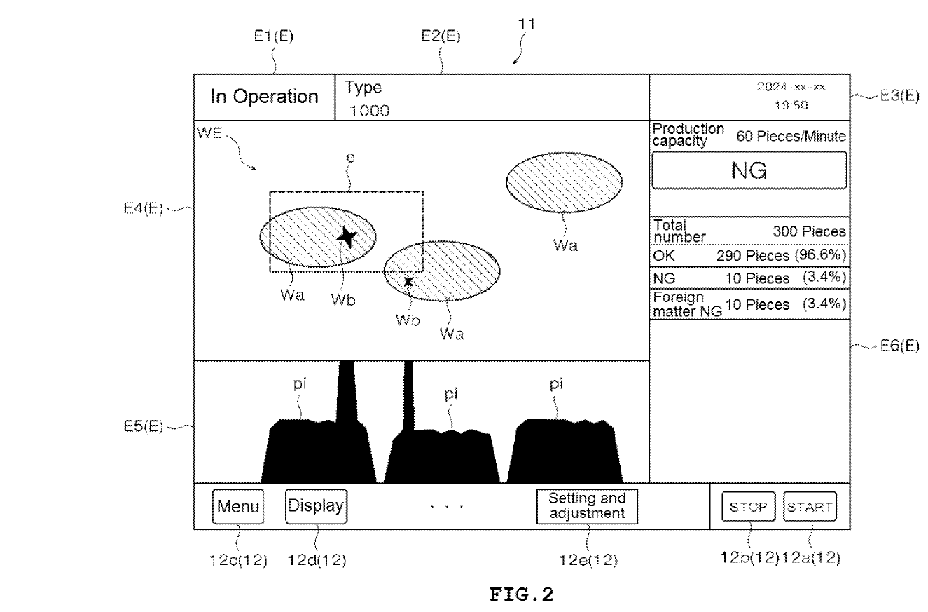

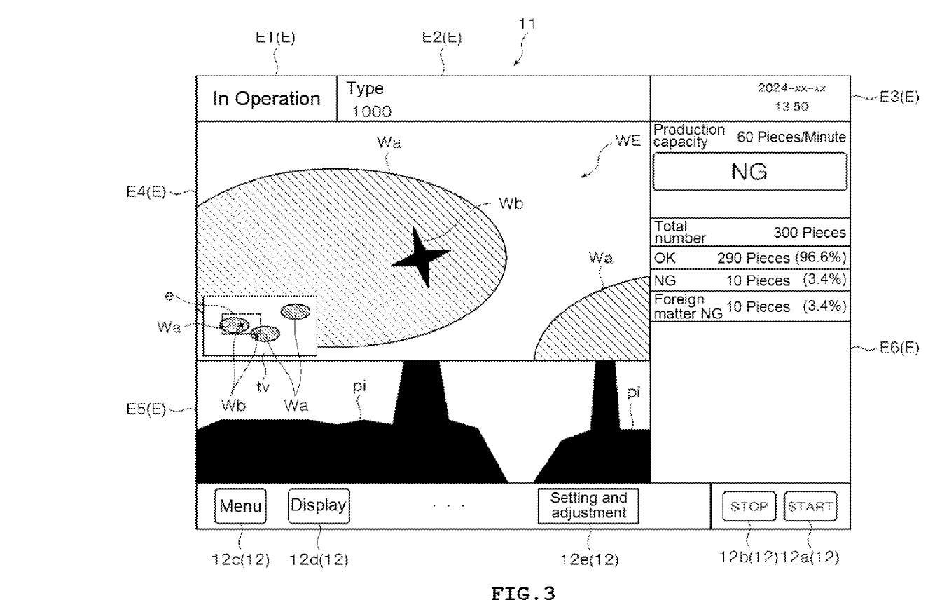

### BRIEF DESCRIPTION OF THE DRAWINGS

[FIG. 1] FIG. 1 is a block diagram showing a schematic configuration of an article inspection device according to the present invention.

[FIG. 2] FIG. 2 is a view showing a display example of an inspection screen during inspection of an inspection object of the article inspection device according to the present invention.

[FIG. 3] FIG. 3 is a view showing a display example when a part of an inspection image of the inspection object on the inspection screen of FIG. 2 is enlarged.

### BEST MODE FOR CARRYING OUT THE INVENTION

Hereinafter, an embodiment of the present invention will be described in detail with reference to the accompanying drawings.

As shown in FIG. 1, an article inspection device 1 of the present embodiment is for inspecting quality (a foreign matter, a defect, or the like) of an inspection object W by imaging the transported inspection object W (article to be inspected) and performing image processing on an inspection image of the inspection object W obtained by the imaging and is schematically configured to include a transport unit 2, an imaging unit 3, an image storage unit 4, a display operation unit 5, and a control unit 6.

The transport unit 2 is configured to transport the inspection object W sequentially at a predetermined interval in a transport direction A and is configured with a conveyor that can sequentially transport the inspection object W in the transport direction A (a right direction in FIG. 1) with an upper travel section 2c of a transport belt 2a. The conveyor has a plurality of transport rollers 2b and configured by winding the transport belt 2a around the transport rollers 2b in loop-shaped, and is supported in a housing (not shown). The transport rollers 2b are rotationally driven by a motor (not shown) and are controlled by the control unit 6 such that a predetermined transport speed is obtained.

The imaging unit 3 acquires an inspection image of the inspection object W transported by the transport unit 2 and includes an X-ray generator 3a disposed to be separated above an inspection space (not shown) in the middle of the transport unit 2 at a predetermined height and an X-ray detector 3b disposed in the transport unit 2 to face the X-ray generator 3a.

The X-ray generator 3a generates X-rays having a wavelength and an intensity corresponding to a tube current and a tube voltage by a known X-ray tube and can irradiate the inspection object W or a sample (a good workpiece of the inspection object W, a foreign matter, and the like) on the transport belt 2a with fan beam-shaped X-rays orthogonal to the transport direction A of the transport unit 2 through an X-ray window portion of an outer surrounder (not shown).

Set values of the tube current and tube voltage of the X-ray tube are preferably adjusted according to a material or size (in particular, a dimension in a direction through which the X-rays are transmitted) of the inspection object W, and the set values are determined or selected such that appropriate contrast can be obtained by test imaging using the inspection object W or a sample for a new type.

The X-ray detector 3b includes an X-ray line sensor including a scintillator (not shown) and a photodiode array (not shown), converts X-rays into light with the scintillator, and converts the light into an electrical signal with the photodiode array to output an X-ray image based on X-ray transmission data. The X-ray detector 3b may generate and output an X-ray image using a direct conversion type semiconductor element.

The image storage unit 4 temporarily stores an X-ray image obtained from X-ray transmission data received from the X-ray detector 3b of the imaging unit 3 as an inspection image of the inspection object W.

The display operation unit 5 is operated when performing various types of settings or displays necessary for switching ON/OFF of a power supply, the transport unit 2, and the imaging unit 3, and inspecting the quality of the inspection object W and includes a display unit 5a and designation means 5b.

The display unit 5a displays an inspection image of the inspection object W stored in the image storage unit 4, an inspection result of the inspection object W, and the like on a display screen and displays, on the display screen, an operation button operated when performing various types of settings and display instructions related to quality inspection of the inspection object W.

The designation means 5b is configured with, for example, a touch panel, more specifically, a capacitive touch panel disposed on the display screen of the display unit 5a, with which a multi-touch operation can be performed, and designates any position centered on a portion of an inspection image WE of the inspection object W (to be described later), which is desired to be viewed by a user, displayed on the display unit 5a, by a double tap operation of consecutively performing a “tap” operation, in which the screen on the user's touch panel is touched and immediately releasing the touch, twice within a predetermined time (an operation of quickly and consecutively tapping twice with a fingertip or the like).

Herein, FIG. 2 shows a display example of an inspection screen 11 during inspection of the inspection object W of the article inspection device 1. In addition, FIG. 3 shows a display example when a part of the inspection image WE of the inspection object W in the inspection screen 11 of FIG. 2 is enlarged.

The inspection screen 11 of FIGS. 2 and 3 is divided into six rectangular regions including an inspection state display region E1, a type number display region E2, a common information display region E3, a captured image display region E4, a projection image display region E5, and an inspection information display region E6, and an operation button 12 is disposed at a lowermost portion.

To describe each of the regions E1 to E6, the inspection state display region E1 displays whether or not the inspection object W is being inspected by irradiation with X-rays. As shown in FIGS. 2 and 3, in a case where “In Operation” is displayed in the inspection state display region E1, it indicates that the inspection object W is being inspected by the irradiation with X-rays. On the other hand, in a case where "Stopped" is displayed in the inspection state display region E1, it indicates that the inspection object W is not being inspected because the irradiation with X-rays is not performed.

In the type number display region E2, a number is set according to the type of the inspection object W (for example, meat, fish, processed food, and pharmaceutical products), and a number (in the examples of FIGS. 2 and 3, “1,000”) corresponding to the set type is displayed.

The common information display region E3 displays common information not depending on the type of the inspection object W, which is unique information of the article inspection device 1, such as the current date and time ("2024-xx-xx 13:50" in the examples of FIGS. 2 and 3) and a network connection state.

The captured image display region E4 displays information related to the inspection image (captured image) WE, which is a grayscale image of the inspection object W. Specifically, in the inspection image WE of the captured image display region E4 of FIG. 2, three elliptical portions indicate a content image Wa of the inspection object W, and a black-painted portion in the content image Wa which is a left elliptical portion and a black-painted portion in the content image Wa which is central elliptical portion each indicate a foreign matter image Wb. In addition, in the captured image display region E4 of FIG. 2, a region e surrounded by a dotted line square based on a position and a predetermined enlargement ratio designated by designation means 5b indicates an enlarged region of the inspection image WE (an enlarged region of the inspection image WE centered on a portion designated by the user).

The inspection image WE of the captured image display region E4 of FIG. 3 indicates an enlarged image of the inspection image WE of the region e surrounded by the dotted line square of the captured image display region E4 of FIG. 2 (an enlarged image of the inspection image WE centered on a portion desired to be viewed by the user). In addition, a part of the captured image display region E4 of FIG. 3 (a small square region in the lower left of the captured image display region E4 of FIG. 3) indicates a thumbnail display tv of the entire inspection image WE in the captured image display region E4 of FIG. 2.

Although not particularly shown, in the captured image display region E4 in FIG. 2, a part of the inspection image WE can also be enlarged and displayed with a predetermined position (for example, the center of the selected content image Wa or an apex of a circumscribed square) as reference through the double tap operation of the designation means 5b. In addition, in order to make it easy to understand a portion to be enlarged, the region e surrounded by the dotted line square may be identified and displayed (highlighted) by a rectangular line of a predetermined color set in advance.

The projection image display region E5 displays a projection image pi based on a two-dimensional cross-sectional waveform image in which a maximum value of a density (a peak value of a grayscale level) of the inspection image WE of the inspection object W on one axis, of a horizontal axis (an axis in the transport direction A) and a vertical axis (an axis in a direction orthogonal to the transport direction A), is drawn along the other axis. The projection image display region E5 of FIGS. 2 and 3 displays the projection image pi based on a two-dimensional cross-sectional waveform image in which a maximum value of a density (a peak value of a grayscale level) of the inspection image WE of the inspection object W on the vertical axis (the axis in the direction orthogonal to the transport direction A) is drawn along the horizontal axis (the axis in the transport direction A).

The projection image display region E5 of FIGS. 2 and 3 can also display the projection image pi based on the two-dimensional cross-sectional waveform image in which a maximum value of the density (a peak value of a grayscale level) of the inspection image WE of the inspection object W on the horizontal axis (the axis in the transport direction A) is drawn along the vertical axis (the axis in the direction orthogonal to the transport direction A).

In addition, in the projection image display region E5, the projection image pi of the entire inspection image WE of the inspection object W, which indicates the entire waveform display, and the projection image pi of the inspection image WE of the inspection object W in a section displayed in an enlarged manner, which indicates partial waveform display, can be displayed in conjunction with an enlargement operation of the inspection image WE of the inspection object W or can be also selectively switched and displayed by an operation of the display operation unit 5 after the enlargement operation of the inspection image WE of the inspection object W.

Further, in a case where the inspection image WE of the inspection object W is enlarged, the projection image pi of the inspection image WE of the inspection object W, which is reflected in an enlargement ratio on only the horizontal axis (the axis in the transport direction A), is displayed in the projection image display region E5 in correspondence with the inspection image WE of the inspection object W after the enlargement operation. At this time, the projection image pi of the inspection image WE of the inspection object W, which is reflected in the enlargement ratio on the horizontal axis (the axis in the transport direction A) or the vertical axis (the axis in the direction orthogonal to the transport direction A) can also be selectively switched and displayed in the projection image display region E5 in correspondence with the size of the inspection image WE of the inspection object W displayed after the enlargement operation by the operation of the display operation unit 5.

The inspection information display region E6 displays the latest inspection determination result of the inspection object W, a total inspection result for a set type, and the like as inspection information. Specifically, in the example of FIGS. 2 and 3, Production Capacity: 60 pieces/minute, Total Number of Inspections of Inspection Object W: 300 pieces, Total Number of OK with Respect to Total Number of Inspections: 290 pieces (96.6%), Total Number of NG: 10 pieces (3.4%), and Total Number of Foreign Matter NG: 10 pieces (3.4%) are displayed in the inspection information display region E6 as inspection information.

In addition, a START button 12a, a STOP button 12b, a menu button 12c, a display button 12d, and a setting and adjustment button 12e are disposed as operation buttons 12 on the inspection screen 11 of FIG. 2.

The START button 12a is operated when the quality of the inspection object W is inspected and the operation of the article inspection device 1 is instructed to start (the inspection of the inspection object W is instructed to start).

The STOP button 12b is operated when the quality of the inspection object W is inspected and the operation of the article inspection device 1 is instructed to be stopped (the inspection of the inspection object W is instructed to be stopped).

The menu button 12c is operated when a menu screen for transitioning to another screen such as a display of statistics, a list of types of the inspection object W, or the like is displayed.

The display button 12d is operated, for example, when switching between the projection image pi of the entire inspection image WE of the inspection object W indicating the entire product effect display and the projection image pi of the inspection image WE of the inspection object W in the section in the enlarged display indicating partial product effect display, switching from a display image of the captured image display region E4 to a captured image (taken image) or an inspection result image, or the like.

The setting and adjustment button 12e is operated when calling up a setting adjustment screen for setting switching types of the inspection object W or the like, adjusting inspection parameters such as detection limit values that can set a plurality of values (threshold values) different according to the type of the inspection object W, the type of foreign matter, which is a detected target, or the like, adjusting the transport speed and sorting (classifying) timing, and setting display priority of display content.

The control unit 6 is a device that includes one or a plurality of processors and peripheral circuits thereof and that integrally controls the operation of the article inspection device 1 and includes an inspection processing unit 6A and a display control unit 6B. Specifically, the control unit 6 includes, for example, a central processing unit (CPU) or a graphics processing unit (GPU), a digital signal processor (DSP), a large scale integration (LSI), an application specific integrated circuit (ASIC), a field programmable gate array (FPGA), and the like, controls the operation of each unit (the transport unit 2, the imaging unit 3, the image storage unit 4, and the display operation unit 5) of the article inspection device 1 and executes various types of processing based on a program stored in a storage unit (not shown).

The inspection processing unit 6A performs processing of the inspection image WE of the inspection object W and includes a projection image generation unit 6Aa, an image processing unit 6Ab, and a determination unit 6Ac.

The projection image generation unit 6Aa generates the projection image pi based on the two-dimensional cross-sectional waveform image in which the maximum value of the density (the peak value of the grayscale level) of the inspection image WE of the inspection object W on the one axis, of the horizontal axis (the axis in the transport direction A) and the vertical axis (the axis in the direction orthogonal to the transport direction A), is drawn along the other axis.

The image processing unit 6Ab performs image processing, in which feature extraction, filter processing for emphasizing a foreign matter, and the like are combined using any of a plurality of inspection algorithms, on the inspection image WE of the inspection object W based on an X-ray image stored in the image storage unit 4. In addition, the image processing unit 6Ab generates a processed image based on a two-dimensional image corresponding to plan view of the inspection object W based on the inspection image WE (grayscale image) of the inspection object W that has been subjected to the image processing.

The determination unit 6Ac executes determination processing of a quality state (for example, determination processing of the presence or absence of a foreign matter) of the inspection object W based on image data after the processing by the image processing unit 6Ab. The image processing unit 6Ab compares a processed image that has been subjected to image processing and the detection limit value set in advance for each inspection algorithm to each other and determines the presence or absence of foreign matter or the presence or absence of a defect in the inspection object W based on the comparison result. Then, in each inspection algorithm used in the inspection, the determination unit 6Ac determines that the inspection object W is a defective product when the processed image subjected to the image processing exceeds the detection limit value.

The display control unit 6B displays an inspection result of the inspection object W on the display unit 5a in, for example, the display format shown in FIGS. 2 and 3 based on a transmission image of each inspection object W, the projection image pi generated by the projection image generation unit 6Aa, a processed image subjected to image processing and output from the image processing unit 6Ab, and a quality determination result of the determination unit 6Ac.

Next, an operation in a case where the quality of the inspection object W is inspected by the article inspection device 1 configured as described above will be described.

First, when the power supply of the article inspection device 1 is switched from OFF to ON by the operation of the display operation unit 5, the transport unit 2 and the imaging unit 3 (the X-ray generator 3a and the X-ray detector 3b) are switched from OFF to ON. After then, when the START button 12a of the operation button 12 of the inspection screen 11 of FIG. 2 is pressed, the inspection object W is sequentially transported at a predetermined interval in the transport direction A by the transport unit 2. Then, the inspection object W on the transport belt 2a is irradiated with X-rays from the X-ray generator 3a, the X-rays transmitted through the inspection object W are detected by the X-ray detector 3b, and an X-ray image based on X-ray transmission data according to the amount of transmission of the X-rays is output.

Then, the X-ray image based on the X-ray transmission data from the X-ray detector 3b is sequentially and temporarily stored in the image storage unit 4 as the inspection image WE of the inspection object W. After then, the projection image generation unit 6Aa of the control unit 6 generates the projection image pi based on the two-dimensional cross-sectional waveform image in which the maximum value of the density (the peak value of the grayscale level) of the inspection image WE of the inspection object W on the one axis, of the horizontal axis (the axis in the transport direction A) and the vertical axis (the axis in the direction orthogonal to the transport direction A), is drawn along the other axis.

In addition, the image processing unit 6Ab of the control unit 6 performs, for example, image processing, in which feature extraction and filter processing for emphasizing a foreign matter, and the like are combined, on the inspection image WE of the inspection object W, which is based on an X-ray image stored in the image storage unit 4 and generates a processed image for a two-dimensional image of the inspection object W based on the inspection image WE (grayscale image) of the inspection object W that has been subjected to the image processing.

Further, the determination unit 6Ac of the control unit 6 executes determination processing of a quality state of the inspection object W (for example, determination processing of the presence or absence of a foreign matter) based on image data after processing by the image processing unit 6Ab.

Then, for example, as shown in FIG. 2, the display control unit 6B of the control unit 6 displays the inspection image WE (including the content image Wa and a foreign matter image Wb) of the inspection object W in the captured image display region E4 of the inspection screen 11 of the display unit 5a based on a processed image processed by the image processing unit 6Ab of the control unit 6.

In addition, for example, as shown in FIG. 2, the display control unit 6B of the control unit 6 displays the projection image pi corresponding to the inspection image WE of the inspection object W generated by the projection image generation unit 6Aa of the control unit 6 in the projection image display region E5 of the inspection screen 11 of the display unit 5a.

Further, as shown in FIG. 2, the display control unit 6B of the control unit 6 displays, in the inspection information display region E6 of the inspection screen 11 of the display unit 5a, for example, Production Capacity, Total Number of Inspections of Inspection Object W, Total Number of OK with Respect to Total Number of Inspections, and Total Number of NG, and Total Number of Foreign Matter NG based on the determination result of the determination unit 6Ac of the control unit 6.

Herein, in a case where a part of the inspection image WE of the inspection object W is enlarged in the captured image display region E4 of the inspection screen 11 of FIG. 2, the designation means 5b of the display operation unit 5 designates a portion of the inspection image WE of the inspection object W, which is desired to be viewed by the user. Accordingly, as shown in FIG. 3, in the region e surrounded by the dotted line square of the captured image display region E4 of FIG. 2, an enlarged image centered on the portion of the inspection image WE, which is desired to be viewed by the user, is displayed in the captured image display region E4 of the inspection screen 11, and the thumbnail display tv of the entire inspection image WE in the captured image display region E4 of FIG. 2 is displayed in a lower left region of the captured image display region E4. At this time, as shown in FIG. 3, the projection image pi in conjunction with an enlargement operation of the inspection image WE of the inspection object W of FIG. 2 (the projection image pi corresponding to the enlarged image of the inspection image WE of the region e of FIG. 2) is displayed in the projection image display region E5.

In addition, while the enlarged image is being displayed, the display returns to the normal display having the size before enlargement through double tapping the inside of the captured image display region E4, and inspection is performed in a state where the enlarged display is maintained until there is designation through the double tapping. An enlargement ratio for the enlargement display by the designation means 5b of the display operation unit 5 is stored in the storage unit (not shown) as a parameter in advance, further the enlargement ratio can be calculated and stored from the size of the inspection image of the inspection object W with respect to the size of the captured image display region E4 when there is designation. When the inspection of the next inspection object W is performed, the enlarged image enlarged based on the stored enlargement ratio is displayed in the captured image display region E4 for the inspection image WE. In a calculation example of the enlargement ratio, for example, the enlargement ratio at which an image of the designated inspection object W is enlarged and displayed in a maximum possible size in the captured image display region E4 is acquired.

Here, in a case where the imaging unit 3 includes the X-ray generator 3a and the X-ray detector 3b, the inspection object W is irradiated with X-rays from the X-ray generator 3a while being transported, and an X-ray image obtained by detecting the X-rays transmitted through the inspection object W with the X-ray detector 3b is used as the inspection image WE to inspect the quality of the inspection object W has been described as an example in the embodiment described above, but without being limited thereto, it is sufficient that the imaging unit 3 will have a configuration where the inspection image WE of the inspection object W is obtained.

Specifically, the present invention can be applied to an article inspection device in which the imaging unit 3 includes a light projector and a light receiver, the inspection object W is irradiated with light from the light projector instead of X-rays as electromagnetic waves, and the quality of the inspection object W is inspected by detecting light transmitted through the inspection object W or the projected light with the light receiver. In addition, the present invention can also be applied to an article inspection device in which the imaging unit 3 includes an illumination and a camera, the illumination and the camera are disposed to face each other via a gap S between the conveyor on an upstream side and the conveyor on a downstream side, and the quality of the inspection object W is inspected from an image captured by the camera by irradiating the inspection object W with light of the illumination or the like.

As described above, according to the present embodiment, by adopting the capacitive touch panel as the designation means 5b that designates any position of the inspection image WE of the inspection object W, for example, double tapping with two fingers is possible, and operability of the enlargement operation for displaying the inspection image WE of the inspection object W is improved, such as calculating the enlargement ratio with a distance between the two fingers. In addition, it is possible to designate any position by a swipe operation of sliding the touch panel up, down, left, and right while the touch panel is pressed with a finger, operation screens can be switched by a swipe operation with respect to a plurality of operation screens on a setting adjustment screen (not shown) called by the setting and adjustment button 12e shown in FIG. 2, and the operability can be improved.

In addition, by displaying the entire thumbnail of the inspection image WE of the inspection object W, which position of the entire inspection image WE is enlarged when a part of the inspection image WE of the inspection object W is enlarged can be easily ascertained.

Further, when a part of the inspection image WE of the inspection object W is displayed in an enlarged manner, the projection image pi in conjunction therewith can be displayed.

Although a best embodiment of the article inspection device according to the present invention has been described above, the present invention is not limited to the description and the drawings according to this embodiment. That is, it is evident that other embodiments, examples, operation techniques, and the like made by those skilled in the art based on this embodiment are all included in the scope of the present invention.

### DESCRIPTION OF REFERENCE NUMERALS AND SIGNS

1 article inspection device

2 transport unit

2a transport belt

2b transport roller

2c upper travel section

3 imaging unit

3a X-ray generator

3b X-ray detector

4 image storage unit

5 display operation unit

5a display unit

5b designation means

6 control unit

6A inspection processing unit

6Aa projection image generation unit

6Ab image processing unit

6Ac determination unit

6B display control unit

11 inspection screen

12 operation button

12a START button

12b STOP button

12c menu button

12d display button

12e setting and adjustment button

W inspection object

WE inspection image (captured image)

Wa content image

Wb foreign matter

A transport direction

E1 inspection state display region

E2 type number display region

E3 common information display region

E4 captured image display region

E5 projection image display region

E6 inspection information display region

e region (enlarged region)

tv thumbnail display

pi projection image

What is claimed is:

1. An article inspection device that inspects quality of a transported article by imaging the article as an inspection object and performing image processing on an inspection image of the article, which is obtained by the imaging, the article inspection device comprising:
an image storage unit that stores the inspection image of the article;
a display unit that displays the inspection image of the article, which is stored in the image storage unit;
designation means for designating any position of the inspection image of the article, which is displayed on the display unit, through double tapping; and
a display control unit that causes the display unit to display a position of the inspection image of the article, which is designated by the designation means, in an enlarged manner at a predetermined enlargement ratio.

2. The article inspection device according to claim 1,
wherein the display control unit causes an entire inspection image of the article to be displayed as a thumbnail in a part of the display unit.

3. The article inspection device according to claim 1, further comprising:
a projection image generation unit that generates a projection image which is a two-dimensional cross-sectional waveform image in which a maximum value of a density of the inspection image of the article on one axis, of a horizontal axis and a vertical axis in a transport direction, is drawn along the other axis,
wherein the display control unit disposes and displays the projection image created by the projection image generation unit with the horizontal axis in the transport direction as the other axis by making the projection image correspond to the inspection image of the article.

4. The article inspection device according to claim 3,
wherein the projection image is switchable between waveform display of an entire inspection image of the article and waveform display of a section of the inspection image of the article, which is displayed in an enlarged manner.

5. The article inspection device according to claim 1,
wherein the designation means is configured with a capacitive touch panel disposed on the display unit.

6. The article inspection device according to claim 1,
wherein the display control unit returns the inspection image displayed in an enlarged manner to the inspection image of the article before enlargement in response to designation of double tapping of the designation means and causes the display unit to display the inspection image.

7. The article inspection device according to claim 2,
wherein the designation means is configured with a capacitive touch panel disposed on the display unit.

8. The article inspection device according to claim 2,
wherein the display control unit returns the inspection image displayed in an enlarged manner to the inspection image of the article before enlargement in response to designation of double tapping of the designation means and causes the display unit to display the inspection image.

9. The article inspection device according to claim 3,
wherein the designation means is configured with a capacitive touch panel disposed on the display unit.

10. The article inspection device according to claim 3,
wherein the display control unit returns the inspection image displayed in an enlarged manner to the inspection image of the article before enlargement in response to designation of double tapping of the designation means and causes the display unit to display the inspection image.

11. The article inspection device according to claim 4,
wherein the designation means is configured with a capacitive touch panel disposed on the display unit.

12. The article inspection device according to claim 4,
wherein the display control unit returns the inspection image displayed in an enlarged manner to the inspection image of the article before enlargement in response to designation of double tapping of the designation means and causes the display unit to display the inspection image.
